(19) United States
(12) Patent Application Publication
(10) Pub. No.: US 2025/0328169 A1
(43) Pub. Date: Oct. 23, 2025

(54) SUPPORT MEMBER, DISPLAY DEVICE INCLUDING SUPPORT MEMBER AND ELECTRONIC DEVICE INCLUDING DISPLAY DEVICE

(71) Applicant: SAMSUNG DISPLAY CO., LTD., Yongin-si (KR)

(72) Inventors: Sung Ki JUNG, Yongin-si (KR); Hong Kwan LEE, Yongin-si (KR); Hyun Jun CHO, Yongin-si (KR)

(21) Appl. No.: 19/000,342

(22) Filed: Dec. 23, 2024

(30) Foreign Application Priority Data
Apr. 18, 2024 (KR) 10-2024-0052296

(51) Int. Cl. G06F 1/16

(52) U.S. Cl. CPC G06F 1/1656; G06F 1/1616

(57) ABSTRACT

A support member and a display device including the same are disclosed. A support member includes: a first plate, a second plate on the first plate, and a third plate between the first plate and the second plate. The first plate and the second plate include a first carbon fiber reinforced plastic, and the third plate includes a second carbon fiber reinforced plastic different from the first carbon fiber reinforced plastic.

### CROSS-REFERENCE TO RELATED APPLICATION

The present application claims priority to and the benefit of Korean Patent Application No. 10-2024-0052296, filed on Apr. 18, 2024 in the Korean Intellectual Property, the entire disclosure of which is incorporated herein by reference.

### BACKGROUND

### 1. Field

Aspects of embodiments of the present disclosure relate to a support member, a display device including the support member, and an electronic device including the display device.

### 2. Description of the Related Art

As information technology develops, the importance of a display device as a connection medium between a user and information is being emphasized.

### SUMMARY

According to an aspect of embodiments of the present disclosure, a support member having high strength and high heat dissipation characteristics while having a thin thickness, a display device including the support member, and an electronic device including the display device, are provided.

According to one or more embodiments of the present disclosure, a support member includes a first plate, a second plate on the first plate, and a third plate between the first plate and the second plate. The first plate and the second plate may include a first carbon fiber reinforced plastic, and the third plate may include a second carbon fiber reinforced plastic different from the first carbon fiber reinforced plastic.

In one or more embodiments, the first carbon fiber reinforced plastic may include a first resin and a PAN-based carbon fiber, and the second carbon fiber reinforced plastic may include a second resin and a pitch-based carbon fiber.

In one or more embodiments, a fiber area weight (FAW) of the first plate and the second plate may be 15 to 30 g/m².

In one or more embodiments, a fiber area weight (FAW) of the third plate may be 50 to 150 g/m².

In one or more embodiments, a content of the first resin in the second plate may be 30 to 50 wt %.

In one or more embodiments, a content of the second resin in the third plate may be 20 to 40 wt %.

In one or more embodiments, a modulus of the support member may be 30 to 110 GPa.

In one or more embodiments, a bending stiffness of the support member may be 50 to 300 GPa.

In one or more embodiments, a horizontal thermal conductivity of the support member may be 50 to 110 W/m·K.

According to one or more embodiments of the present disclosure, a display device may include a display panel folded based on a folding axis, and a support member provided on a back surface of the display panel. The support member may include a first plate, a second plate disposed on the first plate, and a third plate disposed between the first plate and the second plate. The first plate and the second plate may include a first carbon fiber reinforced plastic, and the third plate may include a second carbon fiber reinforced plastic different from the first carbon fiber reinforced plastic.

In one or more embodiments, the first carbon fiber reinforced plastic may include a first resin and a PAN-based carbon fiber, and the second carbon fiber reinforced plastic may include a second resin and a pitch-based carbon fiber.

In one or more embodiments, a fiber area weight (FAW) of the first plate and the second plate may be 15 to 30 g/m².

In one or more embodiments, a fiber area weight (FAW) of the third plate may be 50 to 150 g/m².

In one or more embodiments, a content of the first resin in the second plate may be 30 to 50 wt %.

In one or more embodiments, a content of the second resin in the third plate may be 20 to 40 wt %.

In one or more embodiments, a modulus of the support member may be 30 to 110 GPa.

In one or more embodiments, a bending stiffness of the support member may be 50 to 300 GPa.

In one or more embodiments, a horizontal thermal conductivity of the support member may be 50 to 110 W/m·K.

In one or more embodiments, the display device may further include a protective member between the display panel and the support member.

In one or more embodiments, the display device may further include a digitizer on a back surface of the support member.

According to one or more embodiments of the present disclosure, an electronic device may include a processor to provide an image data signal, and a display device to display an image based on the image data signal. The display device may include a display panel folded based on a folding axis, and a support member provided on a back surface of the display panel. The support member may include a first plate, a second plate disposed on the first plate, and a third plate disposed between the first plate and the second plate. The first plate and the second plate may include a first carbon fiber reinforced plastic, and the third plate may include a second carbon fiber reinforced plastic different from the first carbon fiber reinforced plastic.

### BRIEF DESCRIPTION OF THE DRAWINGS

The above and other aspects and features of embodiments according to the present disclosure will become more apparent by describing, in further detail, aspects of some embodiments thereof with reference to the accompanying drawings, in which:

FIGS. 1 and 2 are perspective views of a display device according to one or more embodiments.

FIGS. 3 and 4 are perspective views of a display device according to one or more embodiments.

FIG. 5 is a cross-sectional view of a display device taken along the line I-I′ of FIG. 1.

FIG. 6 is an exploded perspective view of a support member according to one or more embodiments.

FIGS. 7 and 8 are cross-sectional views of a second plate of a support member taken along the line II-II′ of FIG. 6.

FIG. 9 is a block diagram of an electronic device according to one or more embodiments.

FIG. 10 shows schematic views of an electronic device according to one or more embodiments.

### DETAILED DESCRIPTION

Herein, some example embodiments of the present disclosure will be described in further detail with reference to the accompanying drawings. It is noted that in the following description, the parts necessary to understand the operation according to the present disclosure will be described, and descriptions of other parts may be omitted in order to not obscure the gist of the present disclosure. In addition, the present disclosure is not limited to the embodiments described herein and may be embodied in other forms. The embodiments described herein are provided to explain the present disclosure in further detail so as to enable those skilled in the art to easily implement the technical idea of the present disclosure.

Throughout the specification, in a case in which a portion is “connected” to another portion, the case includes not only a case in which the portion is directly connected but also a case in which the portion is indirectly connected with one or more other elements interposed therebetween. Terms used herein are for describing specific embodiments and are not intended to limit the present disclosure. Throughout the specification, in a case in which a certain portion “includes,” the case means that the portion may further include another component without excluding another component unless otherwise stated. “At least any one of X, Y, and Z” and “at least any one selected from a group consisting of X, Y, and Z” may be interpreted as one X, one Y, one Z, or any combination of two or more of X, Y, and Z (for example, XYZ, XY, YZ, and ZZ). Here, “and/or” includes all combinations of one or more of corresponding configurations.

Here, terms such as “first” and “second” may be used to describe various components, but these components are not limited to these terms. These terms are used to distinguish one component from another component. Therefore, a “first” component may refer to a second component within a range without departing from the scope disclosed herein.

Spatially relative terms, such as “under,” “on,” and the like may be used for descriptive purposes, thereby describing a relationship between one element or feature and another element(s) or feature(s) as shown in the drawings. Spatially relative terms are intended to include other directions in use, in operation, and/or in manufacturing, in addition to the direction depicted in the drawings. For example, when a device shown in the drawing is turned upside down, elements depicted as being positioned “under” other elements or features are positioned in a direction “on” the other elements or features. Therefore, in an embodiment, the term “under” may include both directions of on and under. In addition, the device may face in other directions (for example, rotated 90 degrees or in other directions) and, thus, the spatially relative terms used herein are interpreted according thereto.

Various embodiments are described with reference to drawings schematically illustrating example or ideal embodiments. Accordingly, it will be expected that shapes may vary, for example, according to tolerances and/or manufacturing techniques. Therefore, the embodiments disclosed herein are not to be construed as being limited to shown specific shapes, and are to be interpreted as including, for example, changes in shapes that may occur as a result of manufacturing. As described above, the shapes shown in the drawings may not show actual shapes of areas of a device, and the present embodiments are not limited thereto.

Herein, some aspects of some embodiments of the present disclosure will be described in further detail with reference to the accompanying drawings.

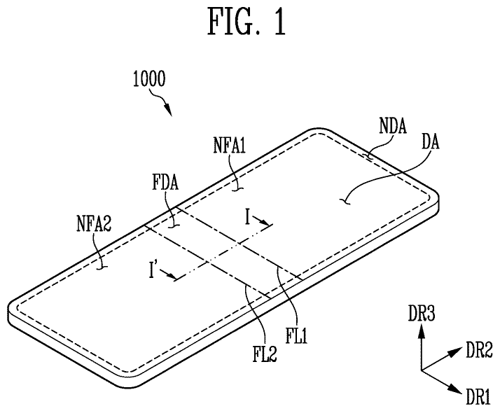

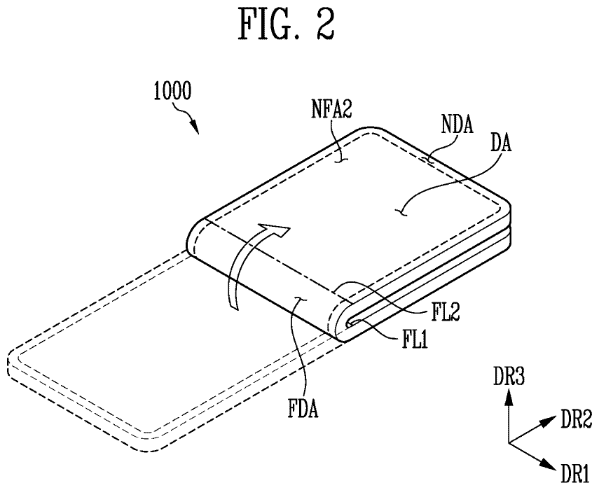

FIGS. 1 and 2 are perspective views of a display device according to one or more embodiments. FIG. 1 shows the display device in an unfolded state according to one or more embodiments. FIG. 2 shows the display device in a folded state according to one or more embodiments.

Referring to FIGS. 1 and 2, a first direction DR1 may be parallel to a first side of a display device 1000 on a plane. For example, the first direction DR1 may be a horizontal direction of the display device 1000. A second direction DR2 may be parallel to a second side that is in contact with first side of the display device 1000 on a plane. For example, the second direction DR2 may be a vertical direction of the display device 1000. A third direction DR3 may be a thickness direction of the display device 1000.

In an embodiment, the display device 1000 may have a rectangular or square shape. For example, the display device 1000 may have a rectangular shape with vertical corners or a rectangular shape with rounded corners. The display device 1000 may include two short sides arranged in the first direction DR1 and two long sides arranged in the second direction DR2.

The display device 1000 may include a display area DA and a non-display area NDA. In an embodiment, a shape of the display area DA may correspond to the shape of the display device 1000. For example, the display device 1000 may have a rectangular shape, and the display area DA may also have a rectangular shape.

The display area DA may include a plurality of pixels and may be an area where an image is displayed. The plurality of pixels may be arranged in row and column directions. The plurality of pixels may have a rectangular, diamond, or square shape, but embodiments of the present disclosure are not limited thereto. For example, the plurality of pixels may have a rectangular shape, a diamond shape, a rectangular shape other than a square, a polygonal shape other than a square, a circular shape, or an oval shape.

The non-display area NDA may not include pixels and may be an area where an image is not displayed. The non-display area NDA may be disposed around the display area DA. In an embodiment, the non-display area NDA may be disposed to surround the display area DA, but embodiments of the present disclosure are not limited thereto. For example, the display area DA may be partially surrounded by the non-display area NDA.

As shown in FIG. 2, the display device 1000 may be folded in an in-folding manner such that the display area DA is disposed on the inside. When the display device 1000 is folded in an in-folding manner, a front surface of the display device 1000 may face itself. However, the display device 1000 may be folded in an out-folding manner such that the display area DA is disposed on the outside. When the display device 1000 is folded in an out-folding manner, a back surface of the display device 1000 may face itself.

The display device 1000 may include a folding area FDA, a first non-folding area NFA1, and a second non-folding area NFA2. The folding area FDA may be an area where the display device 1000 is bent or folded. The first non-folding area NFA1 and the second non-folding area NFA2 may be areas where the display device 1000 is not bent or folded.

The first non-folding area NFA1 may be disposed on a side of the folding area FDA, for example, on an upper side. The second non-folding area NFA2 may be disposed on another side of the folding area FDA, for example, on a lower side. The folding area FDA may be an area defined by a first folding line FL1 and a second folding line FL2 and may be an area that can be bent to a curvature (e.g., a predetermined curvature). The first folding line FL1 may be a boundary between the folding area FDA and the first non-folding area NFA1, and the second folding line FL2 may be a boundary between the folding area FDA and the second non-folding area NFA2. A folding axis may be located in the folding area FDA.

When the first folding line FL1 and the second folding line FL2 extend in the first direction DR1, the display device 1000 can be folded in the second direction DR2. Since a length of the display device 1000 in the second direction DR2 can be reduced by approximately half, a user can conveniently carry the display device 1000.

When the first folding line FL1 and the second folding line FL2 extend in the first direction DR1, the length of the folding area FDA in the second direction DR2 may be shorter than the length of the folding area FDA in the first direction DR1. In addition, the length of the first non-folding area NFA1 in the second direction DR2 may be longer than the length of the first non-folding area NFA1 in the first direction DR1. In addition, the length of the second non-folding area NFA2 in the second direction DR2 may be longer than the length of the second non-folding area NFA2 in the first direction DR1.

Each of the display area DA and the non-display area NDA may overlap at least one of the folding area FDA, the first non-folding area NFA1, and the second non-folding area NFA2. For example, each of the display area DA and the non-display area NDA may overlap the folding area FDA, the first non-folding area NFA1, and the second non-folding area NFA2.

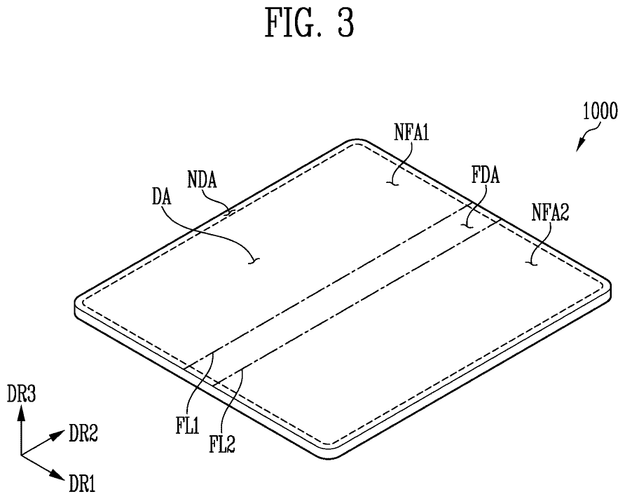

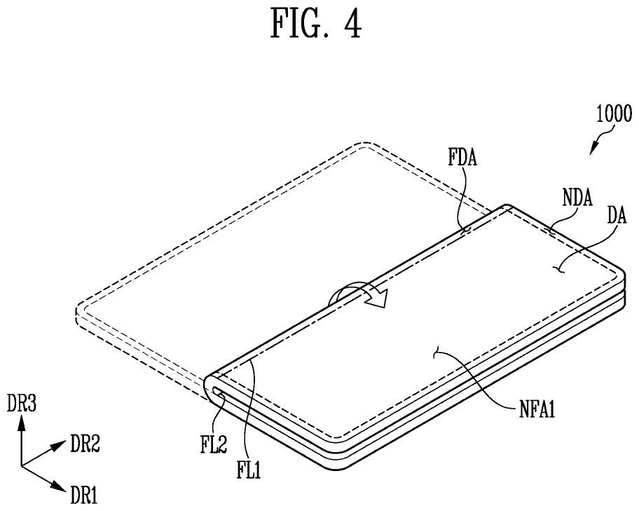

FIGS. 3 and 4 are perspective views of a display device according to one or more embodiments. FIG. 3 shows the display device in an unfolded state according to one or more embodiments. FIG. 4 shows the display device in a folded state according to one or more embodiments. With respect to FIGS. 3 and 4, description that overlaps with FIGS. 1 and 2 will be briefly described or omitted.

Referring to FIGS. 3 and 4, a first folding line FL1 and a second folding line FL2 extend in the second direction DR2, and a display device 1000 can be folded in the first direction DR1. Since the length of the display device 1000 in the first direction DR1 can be reduced by approximately half, a user can conveniently carry the display device 1000.

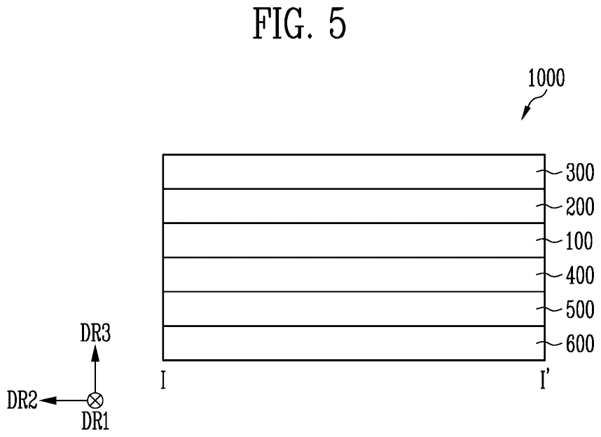

FIG. 5 is a cross-sectional view of a display device taken along the line I-I′ of FIG. 1.

Referring to FIG. 5, in an embodiment, the display device 1000 may include a display panel 100, an optical member 200, a window 300, a protective member 400, a support member 500, and a digitizer 600.

The display panel 100 may be an output device that displays an image. For example, the display panel 100 may display an image through the display area DA, and a user may acquire information through the image. The display panel 100 is made of a flexible material and can be transformed into various shapes. For example, the display panel 100 may be flexible, stretchable, foldable, bendable, or rollable. As an example, the display panel 100 may be folded based on the folding axis located in the folding area FDA (see FIG. 1).

The optical member 200 may be disposed on the display panel 100. The optical member 200 may reduce external light reflectance of the display panel 100 with respect to light incident on the display panel 100. For example, the optical member 200 may include at least one of an anti-reflection film, a polarizing film, and a color filter. However, embodiments of the present disclosure are not limited thereto.

The window 300 may be disposed on the optical member 200. The window 300 may constitute a front surface of the display device 1000 and may protect the display panel 100. The window 300 may include a material with high light transmittance. For example, the window 300 may include a glass substrate, a sapphire substrate, or a plastic film. The window 300 may have a multi-layer structure or a single-layer structure. For example, the window 300 may have a multi-layer structure of plastic films bonded with an adhesive or a multi-layer structure of a glass substrate and a plastic film bonded with an adhesive. In an embodiment, a functional layer including at least one of an anti-fingerprint layer and a shock absorption layer may be further disposed on the window 300.

The protective member 400 may be disposed on a back surface of the display panel 100. The protective member 400 may support the display panel 100 and may protect the display panel 100 from external shock. In an embodiment, the protective member 400 may be made of a polymer resin. For example, the protective member 400 may include a polymer resin such as polyethersulfone, polyacrylate, polyether imide, polyethylene naphthalate, polyethylene terephthalate, polyphenylene sulfide, polyarylate, polyimide, polycarbonate, or cellulose acetate propionate. In some embodiments, the protective member 400 may be omitted.

The support member 500 may be provided on the back surface of the display panel 100 to support the display panel 100. The support member 500 may overlap the display panel 100 in the third direction DR3. For example, the support member 500 may be disposed on the back surface of the protective member 400. If the protective member 400 is omitted, the support member 500 may be disposed on the back surface of the display panel 100.

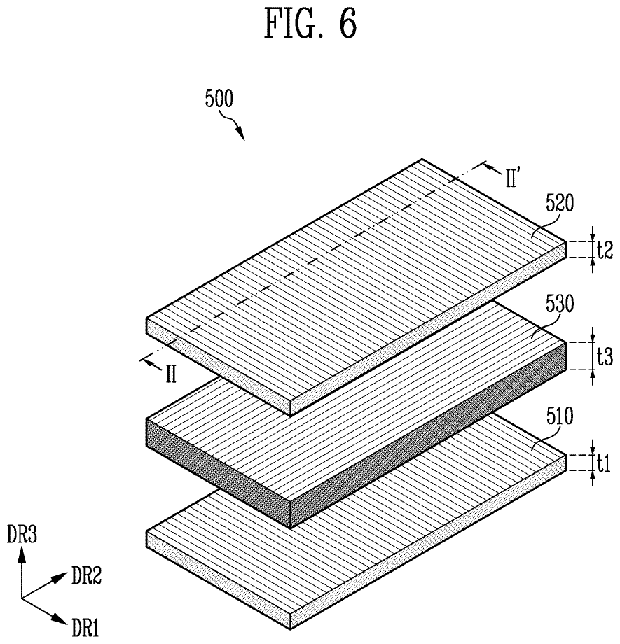

The support member 500 may be made of a non-metallic material. For example, the support member 500 may be made of carbon fiber reinforced plastic, glass fiber reinforced plastic, aramid fiber reinforced plastic, or the like. When the support member 500 is made of a non-metallic material, deterioration in performance of the digitizer 600 due to magnetic field interference can be prevented or substantially prevented. However, embodiments of the present disclosure are not limited thereto. The support member 500 will be described later with reference to FIG. 6.

The digitizer 600 may be disposed on a back surface of the support member 500. The digitizer 600 may detect a signal transmitted by a digitizer pen among external inputs. For example, the digitizer 600 may detect an external input using electromagnetic resonance. A signal may be induced in wirings of the digitizer 600 by the magnetic field generated from the digitizer pen, and a position of the digitizer pen may be detected through the signal induced in the wirings. In some embodiments, the digitizer 600 may be omitted.

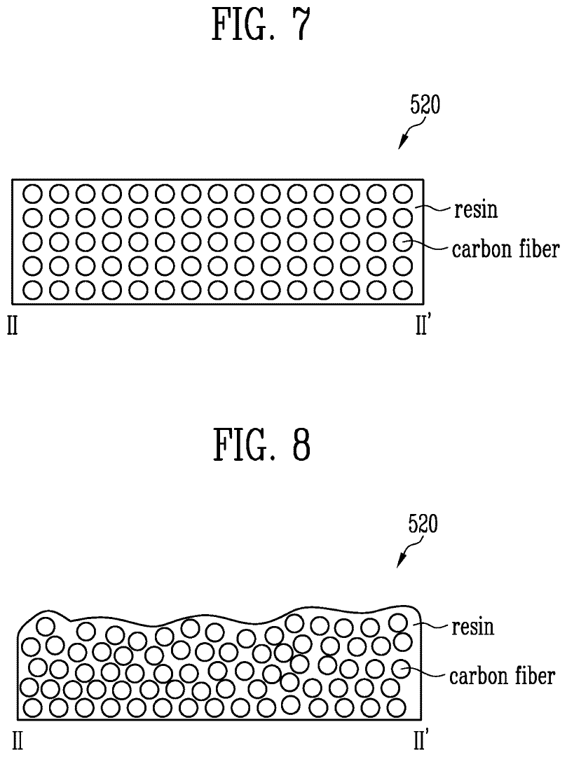

FIG. 6 is an exploded perspective view of a support member according to one or more embodiments. FIGS. 7 and 8 are cross-sectional views of a second plate of a support member taken along the line II-II′ of FIG. 6.

Referring to FIG. 6, the support member 500 may include a first plate 510, a second plate 520, and a third plate 530.

The first plate 510 may constitute a lower layer of the support member 500.

In an embodiment, the first plate 510 may include a first carbon fiber reinforced plastic. For example, the first carbon fiber reinforced plastic may include a first resin and a polyacrylonitrile (PAN)-based carbon fiber. The first resin may be a base material, and the PAN-based carbon fiber may be a reinforcing material. The first resin may include a thermosetting resin, such as epoxy, polyester, vinyl ester, or the like, but embodiments of the present disclosure are not limited thereto. For example, the first resin may include a thermoplastic resin.

In an embodiment, PAN-based carbon fibers included in the first plate 510 may extend in the first direction DR1 and be arranged in the second direction DR2. The PAN-based carbon fibers arranged in the second direction DR2 may be spaced apart from each other by a distance (e.g., a predetermined distance).

In an embodiment, a fiber area weight (FAW) of the first plate 510 may be 15 to 30 g/m². When the FAW of the first plate 510 satisfies the above-mentioned range, the support characteristics of the first plate 510 can be secured.

In an embodiment, the content of resin in the first plate 510 may be 30 to 50 wt %. For example, the content of the first resin in the first plate 510 may be 30 to 50 wt %. When the content of resin in the first plate 510 satisfies the above-mentioned range, the heat dissipation characteristics of the first plate 510 can be secured.

The second plate 520 may constitute an upper layer of the support member 500. For example, the second plate 520 may be disposed on, or over, the first plate 510 to face the first plate 510.

In an embodiment, the second plate 520 may be made of the same material as the first plate 510. For example, the second plate 520 may include the first carbon fiber reinforced plastic including the first resin and the PAN-based carbon fiber. However, embodiments of the present disclosure are not limited thereto. For example, the second plate 520 may include the PAN-based carbon fiber, but may include a resin different from that of the first plate 510.

In an embodiment, PAN-based carbon fibers included in the second plate 520 may extend in the first direction DR1 and be arranged in the second direction DR2. The PAN-based carbon fibers arranged in the second direction DR2 may be spaced apart from each other by a distance (e.g., a predetermined distance). In an embodiment, an arrangement structure of the PAN-based carbon fibers may be the same in the first plate 510 and the second plate 520.

In an embodiment, a FAW of the second plate 520 may be the same as the FAW of the first plate 510. For example, the FAW of the second plate 520 may be 15 to 30 g/m². When the FAW of the second plate 520 satisfies the above-mentioned range, the support characteristics of the second plate 520 can be secured. However, embodiments of the present disclosure are not limited thereto. For example, the FAW of the second plate 520 may be different from the FAW of the first plate 510.

In an embodiment, the content of resin in the second plate 520 may be 30 to 50 wt %. For example, the content of the first resin in the second plate 520 may be 30 to 50 wt %. When the content of resin in the second plate 520 satisfies the above-mentioned range, the heat dissipation characteristics of the second plate 520 can be secured and the surface quality can be improved. Referring to FIG. 7, it can be seen that the surface of the second plate 520 is smooth without any curves. On the other hand, when the content of resin in the second plate 520 is outside the above-mentioned range, both the heat dissipation characteristics and the surface quality of the second plate 520 may not be secured. For example, when the content of resin in the second plate 520 is less than 30 wt %, carbon fibers (or PAN-based carbon fibers) may clump together and the surface quality may deteriorate. Referring to FIG. 8, it can be seen that the surface of the second plate 520 is curved and uneven due to the carbon fibers clumping together. In addition, when the content of resin in the second plate 520 exceeds 50 wt %, the content of carbon fibers, which is a reinforcing material, may decrease, thereby deteriorating the heat dissipation characteristics of the second plate 520.

The third plate 530 may constitute an intermediate layer of the support member 500. For example, the third plate 530 may be disposed between the first plate 510 and the second plate 520.

In an embodiment, the third plate 530 may be made of a different material from the first and second plates 510 and 520. For example, the third plate 530 may include a second carbon fiber reinforced plastic that is different from the first carbon fiber reinforced plastic. The second carbon fiber reinforced plastic may include a second resin and a pitch-based carbon fiber. The second resin may be a base material, and the pitch-based carbon fiber may be a reinforcing material. In an embodiment, the second resin may be the same material as the first resin, but embodiments of the present disclosure are not limited thereto. For example, the second resin may be a different material from the first resin, and the material of the second resin is not particularly limited.

When the third plate 530 is made of the second carbon fiber reinforced plastic including the pitch-based carbon fiber, the thickness may be reduced while securing strength characteristics and heat dissipation characteristics. The strength characteristics may be proportional to the thickness and modulus. For example, the strength characteristics may increase as the thickness and modulus increase. Since the pitch-based carbon fiber has a higher modulus than the PAN-based carbon fiber, the thickness required to secure the same strength characteristics may be reduced. In other words, when the third plate 530 is made of the second carbon fiber reinforced plastic including the pitch-based carbon fiber with a high modulus, the thickness of the support member 500 can be reduced while maintaining the strength characteristics of the support member 500. Accordingly, the overall thickness of the display device 1000 (see FIG. 5) may be reduced. In addition, since the pitch-based carbon fiber has higher thermal conductivity than the PAN-based carbon fiber, the heat dissipation characteristics of the support member 500 including the third plate 530 can be improved.

In an embodiment, an arrangement structure of the pitch-based carbon fibers in the third plate 530 may be different from the arrangement structure of the PAN-based carbon fibers in the first and second plates 510 and 520. For example, the pitch-based carbon fibers included in the third plate 530 may extend in the second direction DR2 and be arranged in the first direction DR1. The pitch-based carbon fibers arranged in the first direction DR1 may be spaced apart from each other by a distance (e.g., a predetermined distance). When the pitch-based carbon fibers included in the third plate 530 are arranged to intersect with the PAN-based carbon fibers included in the first and second plates 510 and 520, the support characteristics of the support member 500 having a sandwich structure can be improved.

In an embodiment, a FAW of the third plate 530 may be 50 to 150 g/m². When the FAW of the third plate 530 satisfies the above-described range, the strength characteristics and heat dissipation characteristics of the support member 500 described above can be secured.

In an embodiment, the content of resin in the third plate 530 may be 20 to 40 wt %. For example, the content of the second resin in the third plate 530 may be 20 to 40 wt %. When the content of resin in the third plate 530 satisfies the above-mentioned range, the heat dissipation characteristics of the third plate 530 can be secured. When the content of resin in the third plate 530 exceeds 40 wt %, the content of the pitch-based carbon fiber, which has excellent thermal conductivity, may be reduced, thereby deteriorating the heat dissipation characteristics of the third plate 530.

In an embodiment, a thickness t3 of the third plate 530 may be greater than a thickness t1 of the first plate 510 and a thickness t2 of the second plate 520. In this case, the strength characteristics and heat dissipation characteristics of the support member 500 can be improved due to the third plate 530 including the PAN-based carbon fiber. However, embodiments of the present disclosure are not limited thereto.

As described above, the support member 500 may have a PAN-pitch hybrid structure. In other words, the first and second plates 510 and 520 may include the PAN-based carbon fiber, and the third plate 530 may include the pitch-based carbon fiber. The support member 500 having the PAN-pitch hybrid structure may have improved characteristics compared to a support member having a PAN single structure. All of plates of the support member having the PAN single structure may include PAN-based carbon fibers. That is, since the support member 500 includes the pitch-based carbon fiber with excellent modulus, thermal conductivity, and the like, the strength characteristics and heat dissipation characteristics of the support member 500 can be improved. For example, the modulus of the support member 500 may be 30 to 110 GPa. In addition, the bending stiffness of the support member 500 may be 50 to 300 GPa. In addition, a horizontal thermal conductivity of the support member 500 may be 50 to 110 W/m·K. Here, the horizontal thermal conductivity may mean thermal conductivity along the second direction DR2. In addition, since there is no need to insert component(s) to supplement strength and heat dissipation between the support member 500 and the display panel 100 (see FIG. 5) and the thickness of the support member 500 can be reduced, the overall thickness of the display device 1000 (see FIG. 5) can be reduced.

The display device 1000 (see FIG. 5) is applicable to various types of electronic devices. In an embodiment, an electronic device may include the above-described display device 1000 and may further include other modules or devices having additional functions other than those of the display device 1000.

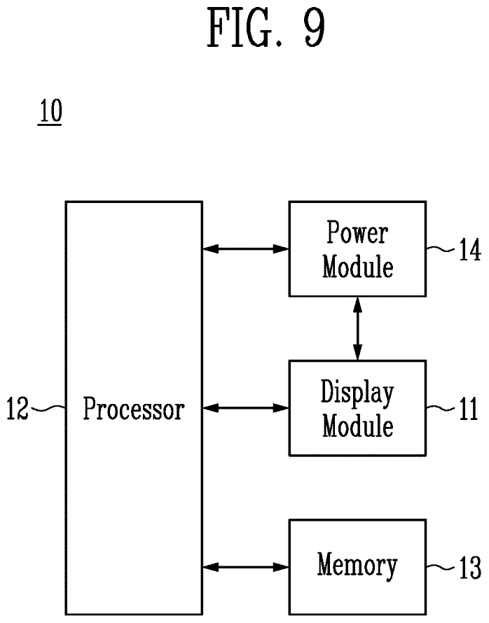

FIG. 9 is a block diagram of an electronic device according to one or more embodiments.

Referring to FIG. 9, the electronic device 10 may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and a controller.

The memory 13 may store data and/or information used to operate the processor 12 or the display module 11. When the processor 12 executes an application stored in the memory 13, an image data signal and/or an input control signal may be transferred to the display module 11. The display module 11 may process the provided signals and output image information on a display screen.

The power module 14 may include a power supply module, such as a power adapter or a battery device, and a power conversion module. The power conversion module converts power supplied by the power supply module and generates power to operate the electronic device 10.

At least one of the above-described components of the electronic device 10 may be included in the display device 1000 (see FIG. 5) according to embodiments as described above. In addition, in terms of functionality, some of the individual modules included in one module may be included in the display device 1000 and others may be provided separately from the display device 1000. For example, the display module 11 is included in the display device 1000, whereas the processor 12, the memory 13, and the power module 14 are not included in the display device 1000 and are provided separately in the electronic device 10.

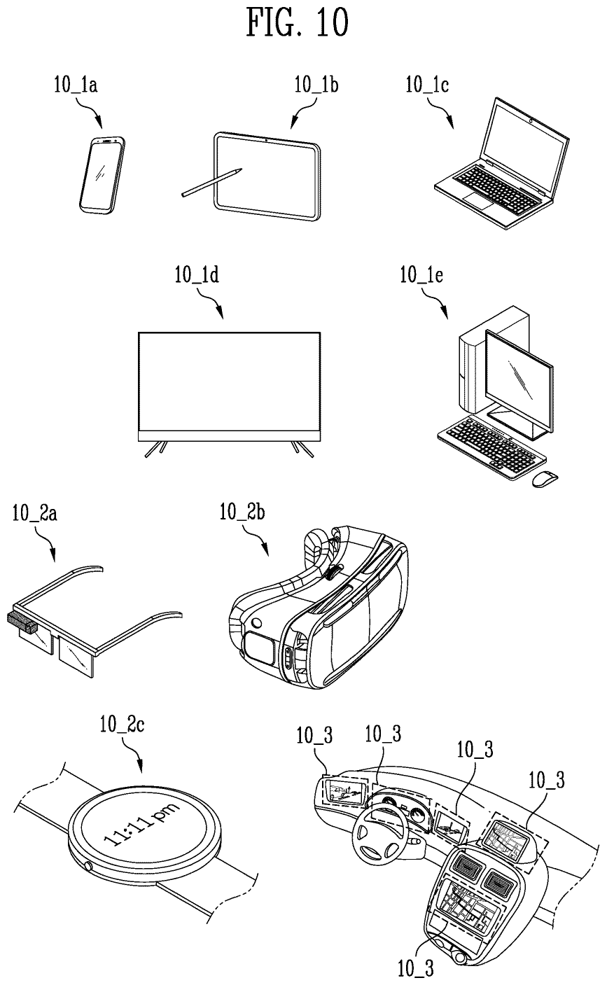

FIG. 10 shows schematic views of an electronic device according to one or more embodiments.

Referring to FIG. 10, various types of electronic devices to which embodiments of display devices are applied may include an electronic device to display images such as a smartphone 10_1a, a tablet PC 10_1b, a laptop computer 10_1c, a television (TV) 10_1d, and a desktop monitor 10_1e, a wearable electronic device including a display module such as smart glasses 10_2a, a head-mounted display (HMD) 10_2b, and a smart watch 10_2c, and an automotive electronic device 10_3 including a display module such as a center information display (CID) disposed at the instrument cluster, the center fascia, and the dashboard of a vehicle, a room mirror display, and the like.

According to embodiments of the present disclosure, a support member having high strength and high heat dissipation characteristics while having a thin thickness, and a display device including the same, are provided.

However, aspects and features of the present disclosure are not limited to those described above, and various other aspects and features will be understood by one of ordinary skill in the art within the spirit and scope of the present disclosure.

The embodiments described above are provided to explain the present disclosure, but these embodiments are not intended to limit the scope of the present disclosure. It will be understood by those skilled in the art that various changes, substitutions, and alternatives may be made therein without departing from the scope of the disclosure as set forth by the claims and their equivalents.

The scope of embodiments according to the present disclosure is not limited by descriptions of the present specification and should be defined by the claims and their equivalents. Further, all changes or modifications of the present disclosure derived from the claims, and equivalents thereof, should be construed as being included in the scope of embodiments according to the present disclosure. Further, the embodiments may be combined to form additional embodiments.

What is claimed is:

1. A support member comprising:
a first plate;
a second plate on the first plate; and
a third plate between the first plate and the second plate,
wherein the first plate and the second plate comprise a first carbon fiber reinforced plastic, and
wherein the third plate comprises a second carbon fiber reinforced plastic different from the first carbon fiber reinforced plastic.

2. The support member according to claim 1, wherein the first carbon fiber reinforced plastic comprises a first resin and a PAN-based carbon fiber, and wherein the second carbon fiber reinforced plastic comprises a second resin and a pitch-based carbon fiber.

3. The support member according to claim 2, wherein a fiber area weight (FAW) of the first plate and the second plate is 15 to 30 g/m².

4. The support member according to claim 3, wherein a fiber area weight (FAW) of the third plate is 50 to 150 g/m².

5. The support member according to claim 2, wherein a content of the first resin in the second plate is 30 to 50 wt %.

6. The support member according to claim 2, wherein a content of the second resin in the third plate is 20 to 40 wt %.

7. The support member according to claim 2, wherein a modulus of the support member is 30 to 110 GPa.

8. The support member according to claim 2, wherein a bending stiffness of the support member is 50 to 300 GPa.

9. The support member according to claim 2, wherein a horizontal thermal conductivity of the support member is 50 to 110 W/m·K.

10. A display device comprising:
a display panel foldable based on a folding axis; and
a support member on a back surface of the display panel,
wherein the support member comprises:
a first plate;
a second plate on the first plate; and
a third plate between the first plate and the second plate,
wherein the first plate and the second plate comprise a first carbon fiber reinforced plastic, and
wherein the third plate comprises a second carbon fiber reinforced plastic different from the first carbon fiber reinforced plastic.

11. The display device according to claim 10, wherein the first carbon fiber reinforced plastic comprises a first resin and a PAN-based carbon fiber, and
wherein the second carbon fiber reinforced plastic comprises a second resin and a pitch-based carbon fiber.

12. The display device according to claim 11, wherein a fiber area weight (FAW) of the first plate and the second plate is 15 to 30 g/m².

13. The display device according to claim 12, wherein a fiber area weight (FAW) of the third plate is 50 to 150 g/m².

14. The display device according to claim 11, wherein a content of the first resin in the second plate is 30 to 50 wt %.

15. The display device according to claim 11, wherein a content of the second resin in the third plate is 20 to 40 wt %.

16. The display device according to claim 11, wherein a modulus of the support member is 30 to 110 GPa.

17. The display device according to claim 11, wherein a bending stiffness of the support member is 50 to 300 GPa.

18. The display device according to claim 11, wherein a horizontal thermal conductivity of the support member is 50 to 110 W/m·K.

19. The display device according to claim 10, further comprising a protective member between the display panel and the support member.

20. The display device according to claim 10, further comprising a digitizer on a back surface of the support member.

21. An electronic device comprising:
a processor to provide an image data signal; and
a display device to display an image based on the image data signal,
wherein the display device comprises:
a display panel foldable based on a folding axis; and
a support member on a back surface of the display panel,
wherein the support member comprises:
a first plate;
a second plate on the first plate; and
a third plate between the first plate and the second plate,
wherein the first plate and the second plate comprise a first carbon fiber reinforced plastic, and
wherein the third plate comprises a second carbon fiber reinforced plastic different from the first carbon fiber reinforced plastic.
